(19) United States
(12) Patent Application Publication
(10) Pub. No.: US 2008/0010134 A1
(43) Pub. Date: Jan. 10, 2008

(54) Methods of advertising using overhead sign structures

(76) Inventor: S. Charles Musumeci, Mahwah, NJ (US)

Correspondence Address: WARD & OLIVO, SUITE 300, 382 SPRINGFIELD AVENUE, SUMMIT, NJ, 07901, US

(21) Appl. No.: 11/455,235

(22) Filed: Jun. 16, 2006

(51) Int. Cl. G06Q 30/00

(52) U.S. Cl. 705/14

(57) ABSTRACT

Methods of advertising are provided. In general, the method entails mounting at least one advertising sign on unused space of an overhead sign structure, (i.e. adjacent to or behind traffic signs), receiving a payment from an advertiser for an advertisement, and displaying the advertisement on the advertising sign. The advertising sign is capable of being interchanged with advertisements. Optionally, a portion of the payment can be delivered to a party associated with managing the overhead sign structure.

### FIELD OF THE INVENTION

The present invention generally relates to the field of advertising. More specifically, the present invention discloses methods of advertising for displaying advertisements using overhead sign structures.

### BACKGROUND OF THE INVENTION

Advertising is an integral aspect of an overall promotional strategy for marketers, advertisers, and manufacturers. Advertising is used to attract public attention to goods, services, companies, and ideas, usually by an identified sponsor. Such desire to attract public attention has caused manufacturers to spend a tremendous amount of money and time developing targeted advertising approaches and techniques. The necessity for targeted advertising has led to an explosion of advertising agencies, developed to act as intermediaries between advertisers and the mass media. The principal function of these advertising agencies is to develop targeted advertisements as well as to obtain space in an appropriate advertising medium and make the space available to the proper clients.

Modern business corporations and advertising agencies make a major effort to upsurge advertising success by researching the projected and actual impact of advertising. Some factors that effect successful advertising are the display period, impression on the desired audience, location of the advertising, and frequency of advertisements. The display period is the interval of exposure when an outdoor advertising campaign is capable of being viewed. Impression is the number of unique people who have an opportunity to view an advertisement in a given period of time. The frequency is the average number of times an individual has the opportunity to see an advertisement during a particular period of time. The chosen medium for advertising significantly effects the above factors as such advertisers work on determining the best and most efficient medium for displaying a particular advertisement.

Traditional advertising is delivered through newspapers, magazines, direct target mail, wall paintings, billboards, flyers, etc. With technological advances advertisers frequently take advantage of electronic media as a medium for advertising. Broadcast technology, such as television, radio, and public networks such as the Internet or World Wide Web, have provided advertisers with capabilities to promote and reach people around the world. As the effectiveness of targeted advertising has grown, it is apparent that specific advertising forms have been able to commend higher fees. For example, television advertising is such a desirable medium that advertisers paid $2.5 million for a thirty second commercial spot during the 2006 Super Bowl. Even though this modern advertising medium might seem attractive, this medium often allows the targeted audience to avoid or side step the displayed advertisement. For example, patrons can avoid advertisements depicted on specific technologies like TiVo®, iPod®, and satellite radio simply by fast forwarding or erasing the content. Such technologies decrease the number of impressions anticipated by advertisers. Older forms of media, such as paper media, billboard media, etc., effectively prevent such avoidance of the targeted media.

Outdoor advertising, specifically billboards used adjacent to highways and roadway locations is one of the most effective forms of advertising not affected by the aforementioned technological drawbacks. In fact, technological advances have only made outdoor advertising more effective. For example, the introduction of LCD billboards, capable of scrolling among advertisements, has proven effective in raising revenue for users of this advertising format. This medium has also proven effective for an advertiser as displays can more effectively grab the attention of the desired audience. In this aspect of outdoor advertising a driver or a passenger of a vehicle needs only to look outside the window to spot an advertisement. In fact, billboard advertising has often been classified as an unavoidable form of media. Outdoor advertising offers constant repetitive exposure, typically for the entire period that such advertisements are displayed, often an entire month—31 days, 24 hours a day—which increases the number of targeted impressions. Furthermore, outdoor advertising is relatively cost effective compared to advertising via electronic media. Overall, no other advertising medium reaches as many people, as often, and at such a low cost. Importantly, outdoor advertising revenues continue to grow every year as more people spend more time traveling in vehicles than in previous years.

In light of such success, today's highways and roadway locations are filled with highway signs, billboard advertising, local business signs, banners, balloons, spot lights, flood lights, flashing lights, and neon signs—just to name a few. Most signs are designed to be seen by traffic traveling in one direction at both minimum and maximum speeds during daylight and nighttime hours. The aforementioned signs lead to the exposure of a particular product, service, company, idea, etc. as the media is glanced at by every driver or passenger traveling on the aforementioned highways.

Typically, erecting signs adjacent to local highways and roadway locations is restricted according to state and local government zoning laws. For example, some states and local governments only permit signs to be erected in industrial and business areas. As a result a permit is required for the advertising sign. This is done to eliminate overcrowding of local highways and roadway locations thus enhancing visual appeal. In 1965 the Highway Beautification Act (HBA) was signed into law by President Johnson to impose regulatory standards for signs located adjacent to “Controlled Areas.” According to the enacted legislation, Controlled Areas cover areas within six hundred and sixty feet of all portions of Federal-Aid Primary, Interstate, and National Highway Systems. The Controlled Area extends to any outdoor advertising sign located beyond six hundred and sixty feet whose message is visible from the Federal-Aid Primary, Interstate, and National Highway Systems. State laws can further restrict the Controlled Area by allowing signs to be placed only in zoned industrial or commercial areas. As such, an outdoor advertising permit is required for each advertising sign within the controlled area. States often further restrict the advertising by enacting ordinances that only allow sign construction in accordance with the state's size, lighting, and spacing standards.

Although the Highway Beautification Act's purpose is to control outdoor advertising, including removal of certain types of signs, today's outdoor advertising remains at peak levels as existing sign structures are erected along almost every national highway. Not only are such structures cluttering the highways, but they also cause a distraction to the driver since the driver all too often takes his or her attention off the roadway and concentrates on an advertisement located roadside and in some cases of significant distance from the road. An efficient way to solve this “cluttering” problem is to utilize existing structures along the highways and roadway locations.

There have been several attempts to utilize existing structures rather than erecting new structures that “litter” the landscape. For example, advertisers lease space on sides of existing buildings, fences, and transit shelters for advertisements. However, such structures are limited to pedestrians and are not an efficient way to gain a driver's or vehicle passenger's attention. Typically these structures are not in close proximity to the roadway user and are not angled correctly to allow the roadway user to spot the advertisement with ease while traveling.

Municipal and state property is also utilized to post advertisements. For example, an additional sign display can be mounted on an existing roadway street sign pole under, above, or adjacent to a road street sign. Alternatively, an advertisement display and street sign can be combined into a single assembly having multiple removable display faces. Local businesses, attractions, stores, restaurants, etc. are often attracted to this type of advertising. Basic traffic signs in close proximately to the advertising business location are also used for the purpose of advertising. This includes the usage of the backside of stop signs, yield signs, speed limit signs and other like signs. A sign display device attaches to the back of the traffic sign and is capable of being interchanged with panels bearing advertisements. Additionally, attachable advertising displays are used in the art for adhering to poles or posts. These advertising displays are attached to traffic signs as well as traffic lights, street light, and gasoline pumps. Such displays are attached to the poles via collars that tightly hug the poles. The advertisement extends from the advertising displays holding interchangeable advertisements. Display assemblies for attaching advertisements to road barriers are also utilized in the art. The road barriers are constructed with openings through which the display assembly is mounted.

Still, the aforesaid advertising systems are inefficient modes for advertising. For example, the described systems are relatively small in size and are not suitable for effective impressions, particularly when compared to common large scale billboards known in the art. Moreover, each sign at best produces nominal revenue. Further, the advertising space is limited to local sites and not sufficient for highways and various roadway locations.

Thus, what is needed is a method of outdoor advertising utilizing existing overhead sign structures which eliminates the need for the construction of additional advertising structures. Furthermore, methods of advertising which make use of existing structures that are easily viewable by the roadway or the highway users is required. Further, methods of advertising are needed in the art that allow advertisers as well as states, municipalities, or the federal government to benefit directly from a share of potential dynamic residual income.

### SUMMARY OF THE INVENTION

One object of the present invention is to utilize overhead sign structures for advertising and in particular to display advertisements on an advertising sign mounted on an overhead sign structure.

Another object of the present invention is to provide advertising signs that meet local, state, and/or government standards, or other standards enforced by regulatory agency or the like.

An additional object of the present invention is to utilize cantilever, arm, truss, beam, plank, single arm, dual arm, dual trussed arm, dual arm butterfly, plane truss, tri-truss, four chord truss, three chord truss, two chord truss, triangular truss, and like overhead sign structures common in the art for advertising.

A further object of the present invention is to display advertisements on advertising signs which include, but are not limited to, an advertisement panel receiving frame, billboard, billboard receiving frame, removable billboard, electronic sign, digital sign, variable message display, light-emitting diodes display, liquid crystal display, or the like.

Another object of the present invention is to display advertisements by removably adhering the advertisements to advertising signs.

One additional object of the present invention is to display advertisements by permanently adhering the advertisements to advertising signs.

In addition, another object of the present invention is to display advertisements by delivering digital content of the advertisements to advertising signs.

Another object of the present invention is to display advertisements by sliding the advertisements into a frame of advertising signs.

A further object of the present invention is to mount advertising signs in an unused space of an overhead sign structure (i.e., space not occupied by a traffic sign).

Another object of the present invention is to mount advertising signs adjacent to traffic signs on an overhead sign structure.

Still a further object of the present invention is to mount advertising signs behind traffic signs on an overhead sign structure.

Another object of the present invention is to maintain a database with records of overhead sign structures, available advertising space and advertising signs.

One additional object of the present invention is to generate advertising revenue that is shared between the local, state, and/or the federal government and the advertiser by making use of available marketing space.

Yet, a further object of the present invention is to offset the overhead sign structure and advertising sign maintenance costs with advertising space costs.

Another object of the present invention is to offset advertisement production costs with advertising fees paid by the manufacturer or the service provider.

A further object of the present invention is to offset the advertising fees paid by the manufacturer or the service provider by the increased sales resulting from the advertising revenue.

In one embodiment of the present invention a method of advertising is disclosed whereby advertising signs are mounted on unused space of an overhead sign structure, a payment is received from an advertiser of an advertisement, a portion of the payment is then delivered to a party associated with management of the overhead sign structure, and the advertisement is displayed on the advertising sign. Importantly, the advertising sign is capable of being interchanged with advertisements and the unused space is defined by space not occupied by a traffic sign.

In another embodiment of the present invention a method of advertising is disclosed whereby an advertising sign is mounted adjacent to at least one traffic sign on an overhead sign structure, a payment is received from an advertiser for an advertisement, and the advertisement is displayed on the advertising sign, wherein the advertising sign is capable of being interchanged with advertisements.

In yet another embodiment of the present invention a method of advertising is disclosed whereby an advertising sign is mounted behind a traffic sign on an overhead sign structure, a payment is received from an advertiser for an advertisement, and the advertisement is displayed on the advertising sign, wherein the advertising sign is capable of being interchanged with advertisements.

### BRIEF DESCRIPTION OF THE DRAWINGS

A further understanding of the present invention can be obtained by reference to preferred embodiments and corresponding alternate embodiments as set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIGS. 1a-1b illustrate a perspective and a pane top view of a one-way span truss overhead sign structure with an advertising sign mounted thereon in accordance with the present invention.

FIGS. 2a-2b illustrate a perspective and a pane top view of a full span truss overhead sign structure with an advertising sign mounted thereon in accordance with the present invention.

FIGS. 3a-3b illustrate a perspective and a pane top view of an arm cantilever overhead sign structure with an advertising sign mounted thereon in accordance with the present invention.

FIGS. 4a-4b illustrate a perspective and a pane top view of a butterfly cantilever overhead sign structure with an advertising sign mounted thereon in accordance with the present invention.

FIG. 5 illustrates a support bracket for mounting an advertising sign to a dual arm overhead sign structure in accordance with the present invention.

FIG. 6 illustrates a side view of a four-chord truss overhead sign structure with two signs mounted thereon in accordance with the present invention.

FIG. 7 illustrates a support bracket for mounting an advertising sign to a single arm overhead sign structure in accordance with the present invention.

FIG. 8 illustrates a side view of a tri-chord truss overhead sign structure with two signs mounted thereon in accordance with the present invention.

FIG. 9 illustrates a billboard-type advertising sign where an advertisement is adhered thereto in accordance with the present invention.

FIG. 10 illustrates an advertising sign comprising sliding brackets for receiving advertisements in accordance with the present invention.

FIG. 11 illustrates a variable message advertising sign in accordance with the present invention.

FIG. 12 illustrates an LCD advertising sign in accordance with the present invention.

FIG. 13 illustrates the flow of revenue generated from advertising on overhead sign structures in accordance with the present invention.

FIG. 14a illustrates an advertising database for maintaining records of available advertising space in accordance with the present invention.

FIG. 14b illustrates a flow diagram of exemplary operation of the database depicted in FIG. 14a in accordance with the present invention.

### DETAILED DESCRIPTION OF THE PREFERRED EMBODIMENTS

Detailed illustrative embodiments of the present invention are disclosed herein. However, techniques, systems, and operating structures in accordance with the present invention may be embodied in a wide variety of forms and modes, some of which may be quite different from those in the disclosed embodiments. Consequently, the specific structural and functional details disclosed herein are merely representative, yet in that regard, they are deemed to afford the best embodiments for the purposes of disclosure and to provide a basis for the claims herein, which define the scope of the present invention. The following presents a detailed description of preferred embodiments (as well as some alternative embodiments) of the present invention.

Referring to the drawings wherein like numerals indicate like elements throughout, shown are various overhead sign structure types with advertising signs displaying advertisements mounted thereon. Overhead sign structures in accordance with the present invention are designed to support signs requiring vertical clearance for vehicles to pass underneath. The overhead sign structures include, but are not limited to cantilevers, arms, trusses, beams, planks, or the like. Normally, these structures span at least a portion of the roadway location including, but not limited to, the shoulder portion of the roadway location. Assembly of such structures includes, but is not limited to a single arm, dual arm, dual trussed arm, dual arm butterfly, plane truss, tri-truss, four chord truss, three chord truss, two chord truss, triangular truss, and the like. Such overhead sign structures are generally located at roadway locations including, but not limited to highways, freeways, thoroughfares, expressways, super highways, arterial highways, thruways, limited-access highways, parkways, interstates, divided highways, or the like. Signs containing traffic related messages are typically mounted on the overhead sign structures facing the oncoming traffic in the corresponding traffic lane. Typically, the forward face portion of the traffic sign (i.e., the side facing the oncoming traffic) provide regulatory, warning, and guide messages designating traffic laws or regulations, road conditions, route designations, route destination, route directions, route distances, services, points of interest, and other geographical, recreation, and cultural information.

Generally, the above listed overhead sign structures are owned by the local, state, and/or the federal authorities. As such, the structures are religiously erected, maintained, and inspected by the local, state, and/or the federal government. Typically an inventory is kept of each overhead sign structure wherein each sign can be identified by a number, location, the date built, and other similar identifying information. For example, the overhead sign structures are inspected by the government within specified periods of time and repaired if needed.

The overhead sign structures allow for relatively large regulatory signs to be displayed. For example, the sign area for a span type overhead sign structure is about twenty feet in height and up to three hundred feet in width. Smaller structures, like a single arm cantilever, are typically about five feet high and ten feet wide, providing a total sign area of fifty square feet.

It is contemplated by the present invention that the use of existing sign structures will benefit the advertiser and the local, state, and/or federal government. In the present embodiment, utilizing the existing structures in the art is beneficial for numerous reasons. For example, the advertiser is not required to spend money and expend resources for building additional structures for advertising signs but is merely required to provide the advertisements of applicable signs. Further, the elimination of additional structures and the utilization of already existing and necessary structures results in a benefit for the local, state and federal government as additional advertising structures will not be erected thereby cluttering the roadway locations. Additionally, the utilization of overhead sign structures attracts more public attention generating higher number of impressions and thus large advertising revenues. Specifically, the signs are clearly visible and a driver or a vehicle passenger need not look beyond the road to view the advertisements. Finally, the advertiser, local, state and/or the federal government can all benefit from the revenues generated from the advertising.

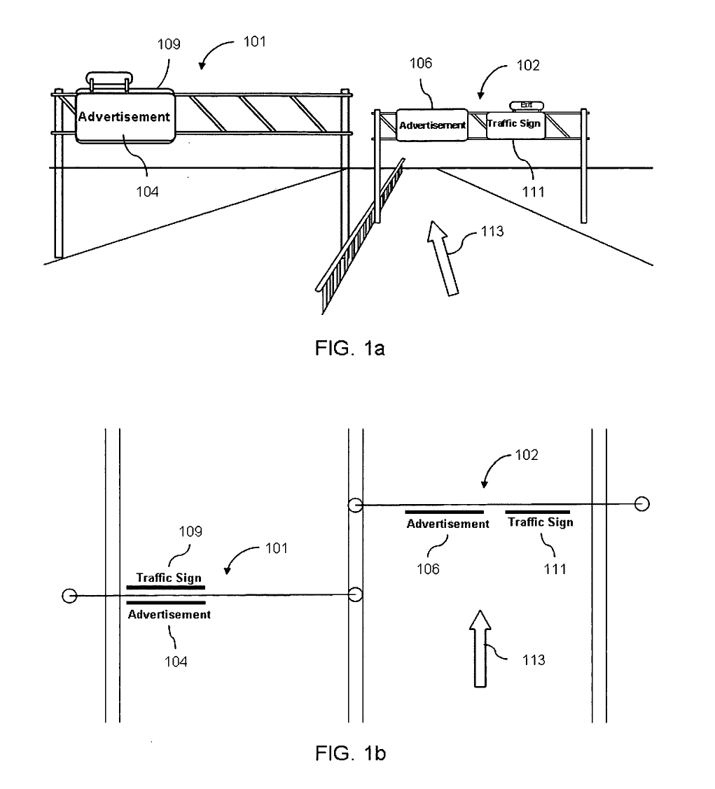

Turning now to FIGS. 1a-1b shown are a perspective view of one-way span truss overhead sign structures 101 and 102 and a pane top view of one-way span truss overhead sign structures 101 and 102 with advertising signs 104 and 106 mounted thereon. Span structures may also be referred to as sign bridges that span over the traveled roadway with supports on both sides of the roadway. Specifically, one-way span truss overhead sign structures 101 and 102 only span one direction of a divided highway. Traditionally, a roadway user traveling in direction 113 can observe traffic sign 111 on the overhead sign structure 102 in the traveling traffic lane but can not see any front portion of traffic sign 109 on overhead sign structure 101 located on the oncoming (non-traveling) traffic lane. In the present invention advertising signs are mounted on unused portions of overhead sign structures adjacent to and/or behind traffic signs, for viewing by persons traveling. As such, advertising sign 106 with a displayed advertisement can be mounted adjacent to traffic sign 111 of overhead sign structure 102. An individual in roadway traveling lane traveling in direction 113 can easily spot the advertisement located directly in front of the traveler on advertising sign 106 without taking much attention from the road. Alternatively, advertising sign 104 can be mounted on overhead structure 101 located on the oncoming (non-traveling) traffic lane facing the traffic traveling in direction 113. Advertisement 104 on advertising sign located on the oncoming lane can still be easily observed by the roadway user traveling in direction 113 since the oncoming traffic lane and its overhead sign structure 101 is generally in a close proximity to the roadway user. Thus, the roadway user does not need to take much attention off the road to observe advertising sign 104. Preferably, advertising sign 104 is mounted behind traffic sign 109. In such a case, advertising sign 104 should be made of a relatively similar size and shape with respect to traffic sign 109 located on the opposing side. This configuration allows mounting of advertising signs while keeping the overall look of the overhead sign structures clean. As such, a user traveling in a roadway traveling lane opposite to direction 113 would not see that there is advertising sign 104 mounted on overhead sign structure 101. Of course, advertising sign 104 as well as advertising sign 106 can be mounted anywhere along the unused space of overhead sign structures 101 and 102 without departing from the spirit of the present invention.

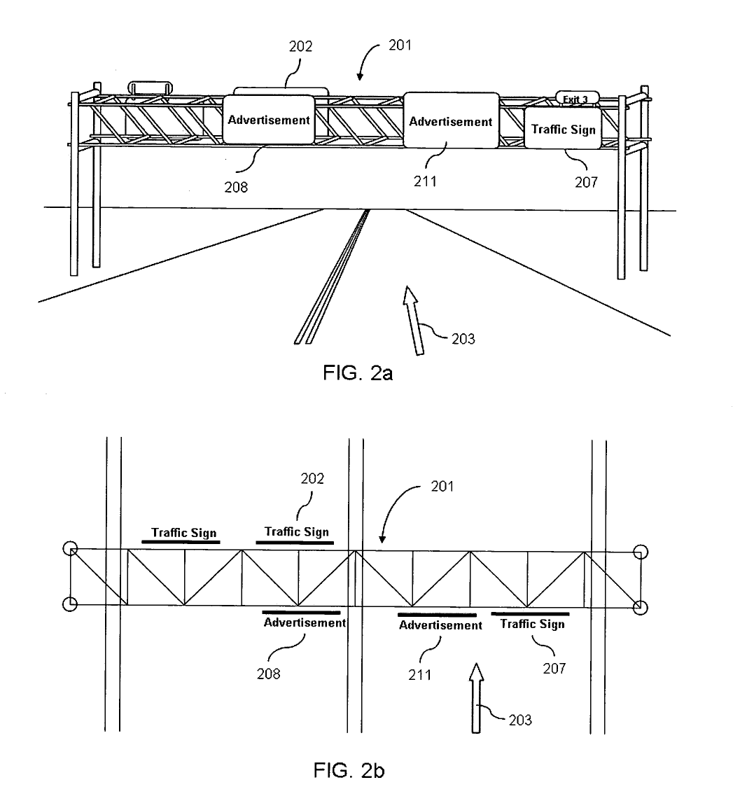

A perspective and a pane top view of a full span truss overhead sign structure 201 of a four-chord truss assembly are illustrated in FIGS. 2a-2b. Span truss overhead sign structures are generally of a large size providing the ideal space for large advertising billboards. In this example, full span truss overhead sign structure 201 spans across both lanes of a roadway location (i.e., lane along traffic direction 203 and lane opposite traveling direction). Depicted is first advertising sign 211 mounted adjacent to traffic sign 207 in the traffic lane along direction 203. Additionally, second advertising sign 208 can be mounted on the opposing side of traffic sign 202 in the oncoming traffic lane but facing the traffic lane of direction 203. A roadway user traveling in direction 203 can easily spot first advertising sign 211 located in his or her traffic lane as well as second advertising sign 208 located in the oncoming traffic lane.

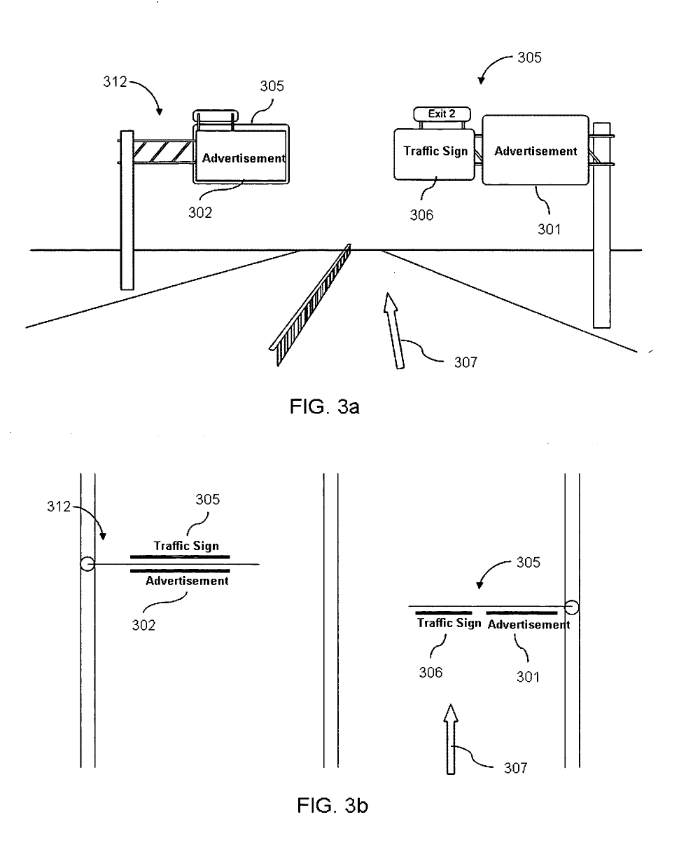

FIGS. 3a-3b illustrate a perspective and a pane top view of arm cantilever overhead sign structures 305 and 312 of a dual trussed arm assembly. Cantilever sign structures extend over the traffic and have support on only one side of the roadway. Sign structure 305 located in traffic lane of direction 307 holds advertising sign 301 and traffic sign 306 adjacent to one another while sign structure 312 located in the oncoming traffic lane holds advertising sign 302 facing the traffic traveling in direction 307 opposing traffic sign 305. The roadway user traveling in direction 307 can easily view advertising signs 301 and 302 regardless of the overhead sign structure location.

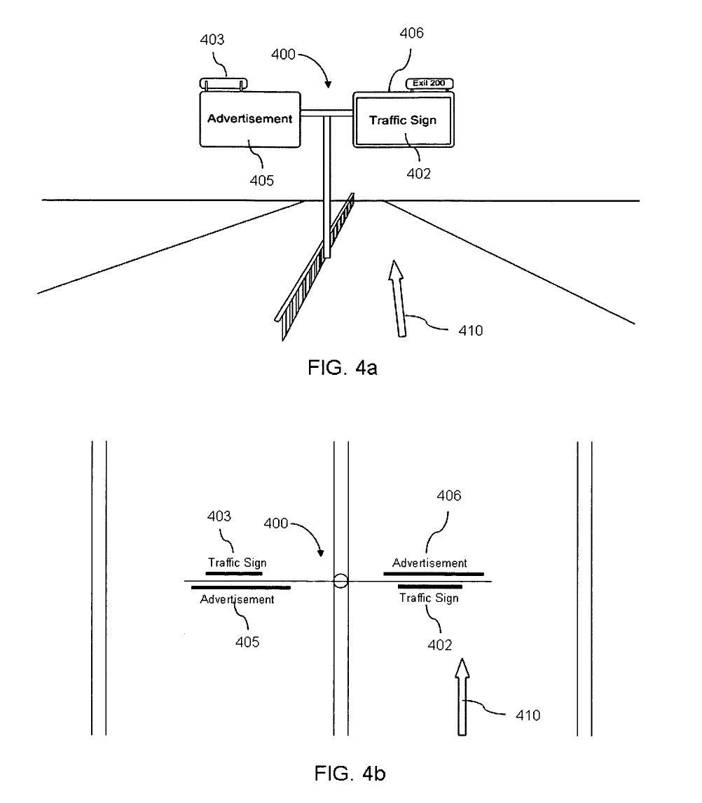

Another example of a sign structure utilized in accordance with the present invention is illustrated in FIGS. 4a-4b. Shown are perspective and pane top view of a butterfly cantilever overhead sign structure 400. This sign structure illustrates a mast arm assembly where a single mast arm cantilevers over the traffic. Traditionally, the butterfly sign structure 400 only displays traffic signs 402 and 403 to traffic traveling in direction 410 and the opposite direction. With the present invention, advertising sign 405 can be mounted on the opposing side of traffic sign 403 allowing a roadway location user traveling in direction 410 to view the advertisement. Advertising sign 406 can be mounted opposite traffic sign 402 viewable by traffic traveling in direction opposing 410. Thus, a single structure can display advertisements to traffic traveling in both directions. Additionally, a smaller sized advertising sign (not shown) can be mounted adjacent to traffic sign 402 on the overhead traffic sign structure 400.

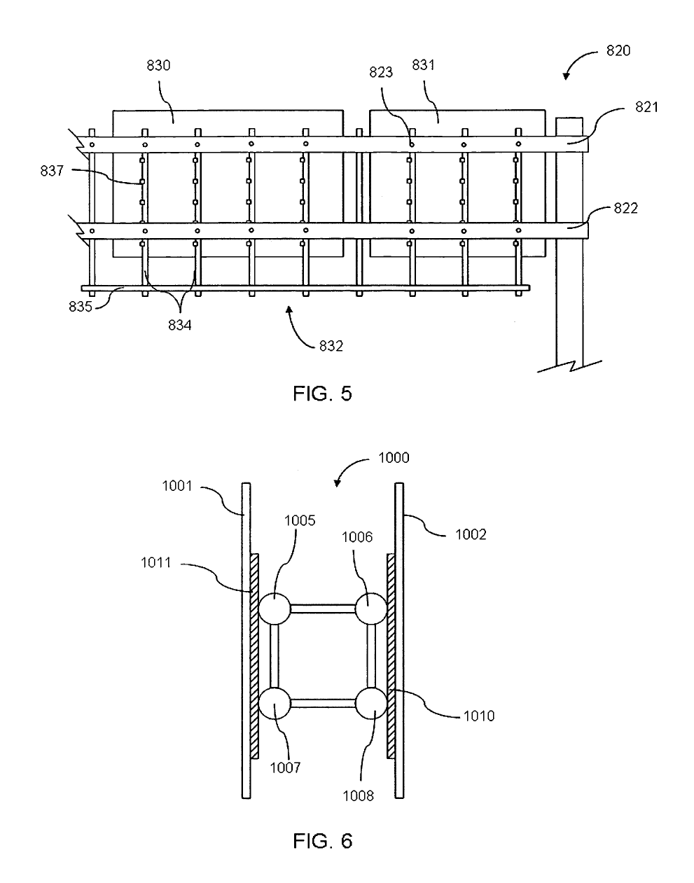

The advertising signs described in the aforementioned figures can be mounted on the overhead sign structures in a similar manner as traffic signs. Sign panels are usually attached to the structure via support brackets and the panel itself is connected to the bracket with sign clips. The support brackets are attached to the sign structures with mounting hardware including, but not limited to aluminum bolts, nuts, steel beveled washers, u-bolts, interlocking brackets, buckle brackets, snap-lock brackets, strapping brackets, metal wires, cables, and other mounting hardware. Specifically, FIG. 5 illustrates support bracket 832 for mounting traffic sign 830 and advertising sign 831 to a dual arm overhead sign structure 820. In this example, traffic sign 830 is utilized for displaying desired traffic or other informational messages and advertising sign 831 is an advertising sign in accordance with the present invention. The overhead sign structure 820 consists of two arms 821 and 822 to which support bracket 832 is attached. Support bracket 832 comprises vertical support angles 834 each attached to sign structure 820 via bolts 823. Of course any other attachment means known in the art, like the mounting hardware described above, can be utilized to attach support bracket 832 to sign structure 820. Horizontal support angles (not shown) can be further utilized to interconnect vertical support angles 834 providing greater stability especially required by large signs. Support bracket 832 can be configured to the size of a single sign or can extend through the entire length of the sign structure to support numeral signs as illustrated in FIG. 5. As such, signs can be mounted on bracket 832 anywhere along sign structure 820. Finally, sign clips 837, or any other mounting hardware known in the art, are utilized to secure sign panels 830 and 831 to sign bracket 832. Walking plank 835 sometimes referred to as catwalk can be mounted on support bracket 832 providing access to the sign panels for maintenance personnel without disturbing the traffic. This is useful for mounting advertising signs and displaying and replacing advertisements.

This mounting configuration applies to any overhead sign structure consisting of at least two vertically parallel horizontal arms which include dual arm, dual trussed arm (e.g., FIG. 3a-3b), dual arm butterfly, plane truss, four chord truss (e.g., FIG. 2a-2b), two chord truss (e.g., FIG. 1a-1b), tri-truss, three chord truss, or similar overhead sign structures. Support bracket 832 can be mounted on either location and side of the above mentioned overhead sign structures.

For example, FIG. 6 illustrates a side view of four-chord truss overhead sign structure 1000 with two signs 1001 and 1002 mounted thereon. Signs 1001 and 1002 are mounted on opposite sides of overhead sign structure 1000. Sign 1001 can be an advertising sign and sign 1002 can be a traffic sign. As such, the traveling traffic not intended to observe the face of traffic sign 1002 can now observe an advertisement on advertising sign 1001. First support bracket 1010 holding traffic sign 1002 is mounted on arms 1006 and 1008 while second support bracket 1011 holding advertising sign 1001 is mounted on opposing arms 1005 and 1007 as previously described. When a two arm configuration is used, as in FIG. 5, support brackets 1010 and 1011 can be mounted on opposing sides of arms 821 and 822.

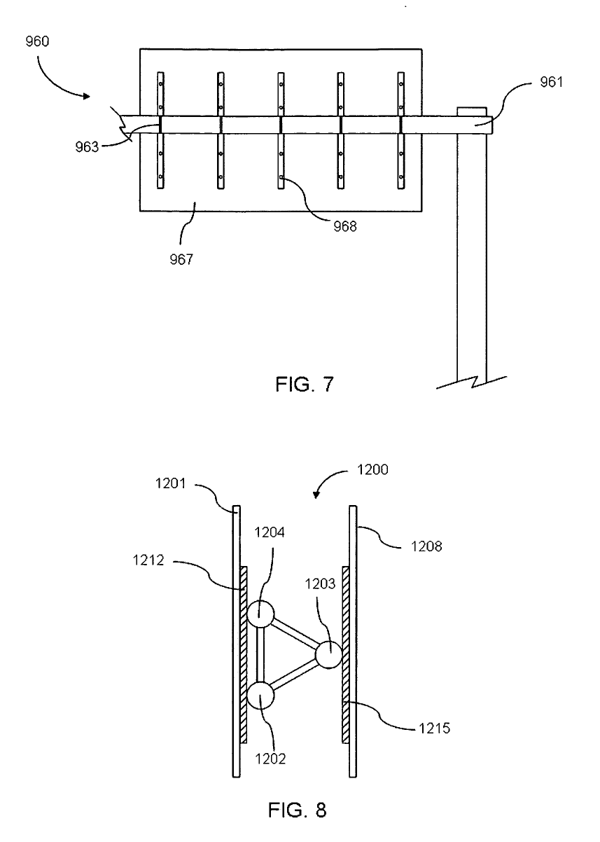

FIG. 7 illustrates a support bracket for mounting advertising sign 967 to a single arm overhead sign structure 960. Support bracket 968 is centered along arm 961 to even out the load and is attached to arm 961 with U-bolts 963. U-bolts 963 are shaped the letter ‘U’ which hugs arm 961 and bolts to support bracket 968. Of course, any other hardware known in the art that effectively attaches support brackets to a single arm of an overhead sign structure can be utilized. In this example, sign panel 967 is connected to support bracket 968 via bolts 968. The mounting configuration illustrated in FIG. 7 can be also utilized for tri-truss, three chord truss, triangular truss, butterfly cantilever (e.g., FIGS. 4a-4b), and other like overhead sign structures. For example, FIG. 8 illustrates a side view of a tri-chord truss overhead sign structure 1200 with two signs mounted thereon in accordance with the present invention. Generally, conventional traffic sign 1201 is attached to support bracket 1212 mounted on chords 1202 and 1204 of overhead sign structure 1200 in similar manner as illustrated in FIG. 5. Advertising sign 1208 can be mounted on the opposing side of conventional traffic sign 1201 via bracket 1215. Support bracket 1215 is mounted on chord 1203 of overhead sign structure 1200 as described in regards to FIG. 7. Additional supports (not shown) can be used to secure support bracket 1215 to overhead sign structure 1200 which extend from support bracket 1215 to chord 1204 and/or chord 1202. As such, larger advertising signs can be mounted.

Traditional billboards as well as more technologically advanced types of advertising signs can be used as the advertising signs in the present invention. For example, advertising signs can include permanent billboards or signs, permanent signs covered with temporary material with printed advertisements, removable billboard or signs, permanent frames containing advertisements, permanent electronic signs, permanent digital signs, permanent variable message signs, permanent LCD signs, permanent LED screens or other similar electronic displays. Each of these types of signs is equipped with fastening hardware as previously described and meets each local, state, and/or federal government minimum standard.

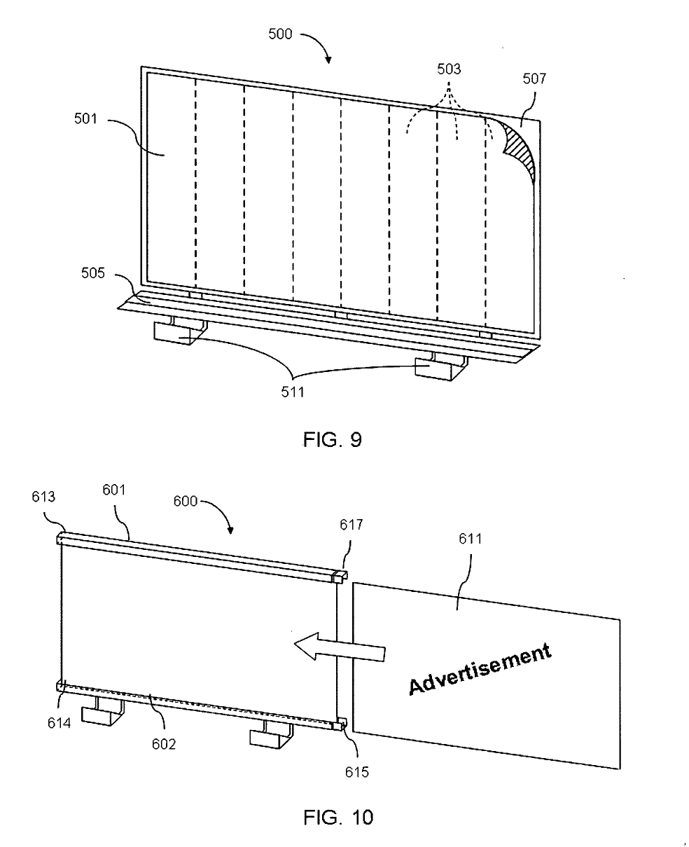

Billboard-type signs generally include different sizes of bulletins or poster panels. FIG. 9 illustrates a billboard-type advertising sign 500. Advertising sign 500 comprises advertising sign panel 507 with advertising poster 501 attached thereto. Depending on the billboard size, advertising poster 501 can consist of one spanning poster that attaches to advertising sign panel 507 with an advertisement printed thereon. When larger billboards are used, multiple posters 503 can be attached to billboard 500 in sections that make up one advertisement. Posters 501/503 can comprise paper materials, vinyls, printed fabrics, reusable printed fabrics, or the like. Preferably, vinyl type systems are preferred as they exhibit extensive benefits. For example, since vinyls are flexible they are easily maneuvered during sign replacement. Further, vinyl type systems are reusable since they are protected with an ultra-violet coating which prevents the advertisement printed thereon from deteriorating from sun exposure.

Different methods and adhesives can be used for attaching advertising posters 501 or 503 to advertising panel 507. When permanent adhering materials are used, new advertisements can be readily pasted on top of old advertisements. Alternatively, temporary adhesive materials can be used allowing for removal of an old advertisement and replacing it with a new advertisement. Advertisements can also be hand painted on wood or other similar material panels that are secured to an advertising sign frame or directly to the support brackets. At the completion of an advertising campaign the panels are whitewashed in preparation for the new campaign. In addition, any other types of billboards and sign replacement techniques known in the art can be utilized without departing from the spirit of the present invention.

Advertising sign panel 507 can be permanently attached to an overhead sign structure via the support brackets as previously described. In such an embodiment only advertisement posters 501 and 503 are regularly replaced for each advertising campaign. Alternatively, advertising sign panel 507 with a pre-attached advertisement can be entirely replaced for each campaign. As such, different sized and shaped advertisements can be displayed according to an advertiser's preference. When a large advertisement is required, advertising panel 507 can be split into sections which make up a single advertising panel. The section can be secured together on site with backing strips. Walking plank 505 is included in advertising sign 500 similar to existing billboards. Plank 505 allows for advertisement replacement without disturbing roadway traffic. The walking plank can be attached directly to advertising sign 500 or can be supported by support brackets. Lighting fixtures 511 can be fastened to advertising sign 500 to illuminate advertisement 501, allowing advertisement 501 to be viewed both day and night. Night lighting can be supplied by tapping into existing power supplies. Other lighting sources for a non-electrified location could include, but are not limited to solar powered lighting units, generators, batteries, or the like.

FIG. 10 illustrates advertising sign 600 for slidable advertising panels 611 with advertisements printed, adhered, or painted thereon as previously discussed. Sliding brackets 601 and 602 are used to slide advertising panel 611 into advertising sign 600. Stop caps 613 and 614 and locking caps 617 and 615 secure advertising panel 611 in place. Locking caps 617 and 615 can swivel from an open position to a locking position after advertising panel 611 had been inserted into advertising sign 600. Such advertising sign configuration is low cost and allows for quick sign replacement or removal. To further simplify the replacement of signs, advertising sign 600 can comprise rollers (not shown) inside sliding bracket 602 and/or 601. As such, advertising panel 611 can be easily rolled into sliding brackets 602 and 601 via the rollers and locked in by locking caps 617 and 615. Further, a transparent panel (not shown) made of glass or plastic material can be secured to brackets 601-602 for protecting advertising panel 611 from sun exposure and weather conditions.

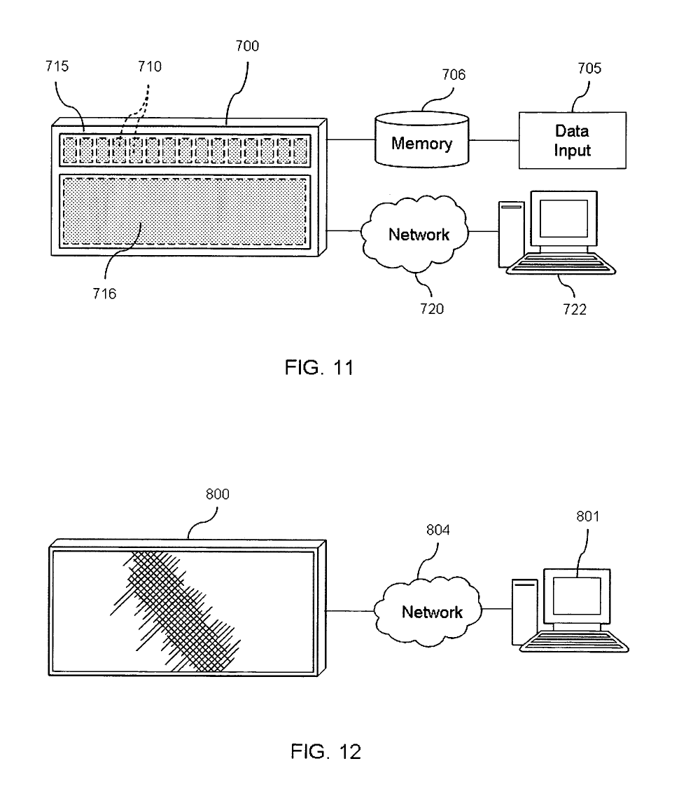

The utilization of more technologically advanced advertising signs, such as digital billboards, simplify sign replacement and enhance the advertising experience. FIG. 11 illustrates variable message advertising sign 700. Such signs utilize a matrix of light-emitting diodes (LEDs) for depicting information. Of course, other variable message technologies can be utilized for the advertising sign without departing from the scope of the present invention. A specified number of LEDs are lit within such matrices to represent a letter, a symbol, or a picture. Sign 700 can consist of matrices 710 each representing a single letter or a symbol. When such matrices 710 are formed into row 715 words and sentences can be formulated. With such configuration, textual advertisements can be displayed. In another embodiment, one spanning matrix 716 can be used to represent a larger variety of data since more combinations of lighted LEDs is available. Advertisements consisting of words, symbols, or pictures can be displayed. Variable sign advertisement 700 and other types of digital displays are capable of providing motion picture advertisements which enhance the advertising experience. Color changing LEDs or a multi color LED clusters can be used to enhance the advertisement with color.

Advertising display 700 can consist of local memory 706 and data input device 705 such as a keyboard, a compact disk, a floppy disc, or the like. The advertisement content can be inputted through data input device 705 and saved on local memory 706 which would provide advertising sign 700 with the advertisement content. Multiple advertisements can be stored in memory 706 and interchanged over a period of time on advertising sign 700. The advertisement content can also be provided remotely to advertising sign 700 through the utilization of network 720, such as the Internet, and computer 722. The advertisement content can be inputted through computer 722 and delivered to advertising display 700 through network 720. Network 720 includes but is not limited to wired, wireless, GSM, ISDN, Ethernet, CATV, WiFi, LAN, Bluetooth, or the like. Computer 722 can store numerous advertisements along with data dictating the advertisement's duration time, display frequency, or the like.

Liquid Crystal Display (LCD) advertising sign 800 can be also utilized to display advertisements, as illustrated in FIG. 12. This type of advertising sign is most visually stimulating due to its clarity and brightness. The advertisement can be displayed and changed instantaneously through computer 801 connected through Internet connection 804. Even though the variable message signs and LCD displays of FIGS. 11-12 are more expensive than typical billboards, they are cost effective in the long run. For example, advertisements are displayed and can be replaced with minimal efforts. Conventional billboards require man power and time to be displayed, while digital billboards achieve this in seconds. The digital billboards are self illuminating and do not require additional lighting fixtures. Importantly, digital billboards can deliver advertisements that are more attractive to the public eye, which generates a larger number of impressions and thus larger advertising revenue.

Each state, local government (e.g. municipality), and the federal government can share the flow of residual income generated by overhead sign structure advertising. There is a constant need for each government to maximize its revenues. The aforementioned resources would be considered prime advertising space for every billboard advertising agency. The demand for this type of space is virtually unlimited since it is sellable to customers of every size and location, including international conglomerates as well as local businesses.

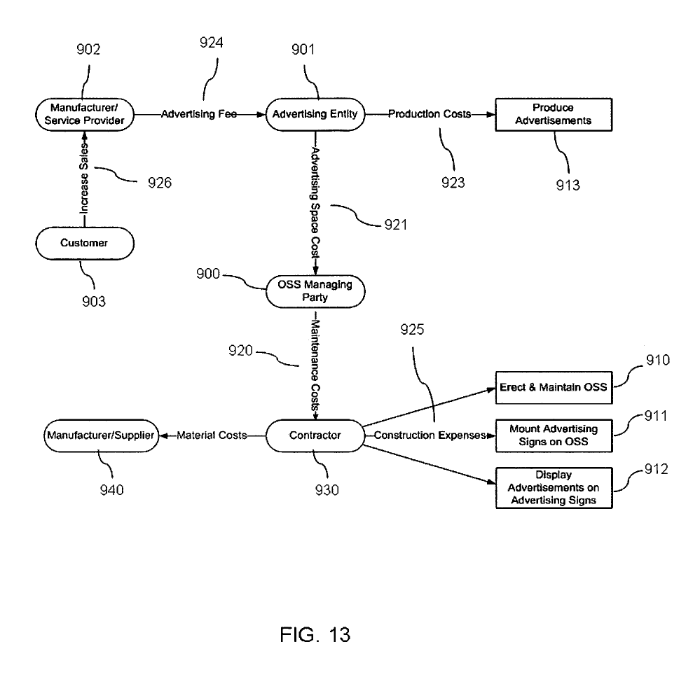

FIG. 13 illustrates a revenue model diagram of revenue flow generated from advertising on overhead sign structures. Overhead sign structures (OSS) managing party 900 can include the local, state, federal government or other controlling entity. For example, other public or private agencies hired by the government can be referred to as the OSS managing party. OSS managing party 900 provides for many functions related to the construction and maintenance of overhead sign structures. Specifically, OSS managing party 900 allocates maintenance costs 920 to contractors 930 or subcontractors that spend construction and maintenance expenses 925 to erect and maintain the overhead sign structures 910. Once it is decided by OSS managing party 900, specifically by a transportation department, that a new overhead sign structure is necessary, contractor 930 is hired for the project. Contractor 930 can employ program managers, construction workers, inspection engineers, site management personnel, designers, and the like to erect and maintain the overhead sign structures. Quality control agents are implemented by OSS managing party 900 as a means and method to assure that the overhead sign structures are property fabricated, erected and constructed by contractor 930. Contractor 930 is responsible for the design and fabrication of the overhead sign structures which are inspected by OSS managing party 900. Overhead sign structure assembly materials, such as end frames, posts, trusses, mast arms, and the like are ordered from manufacturers or suppliers 940. Normally, signs, signals, and other attachments are attached to the overhead sign structure before being erected. Consequently, advertising signs can be mounted to overhead sign structure 911 during such time. Finally, contractor 930 assembles the overhead sign structures in the field which is inspected and numbered for identification by OSS managing party 900. The overhead sign structure identification information as well as design, location, and other pertinent information is stored by OSS management party 900 in a database. The information is later used by inspectors, program manager, and maintenance and repair personnel. The database can additionally store inspection frequency data indicating when inspection is due and prior inspection records.

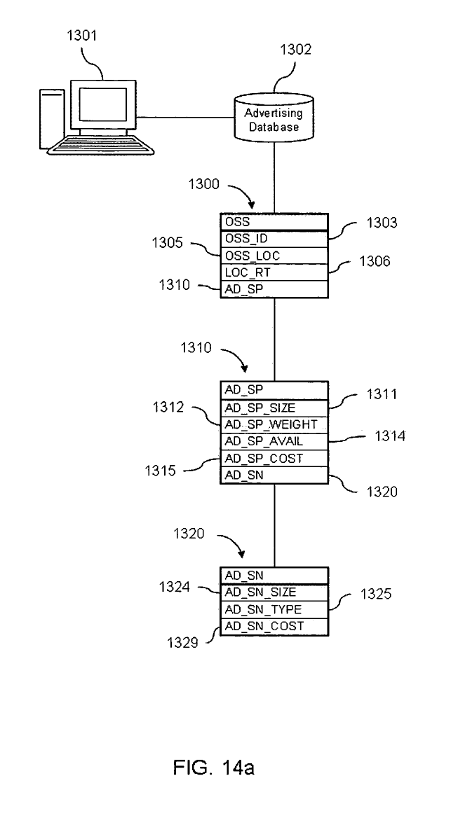

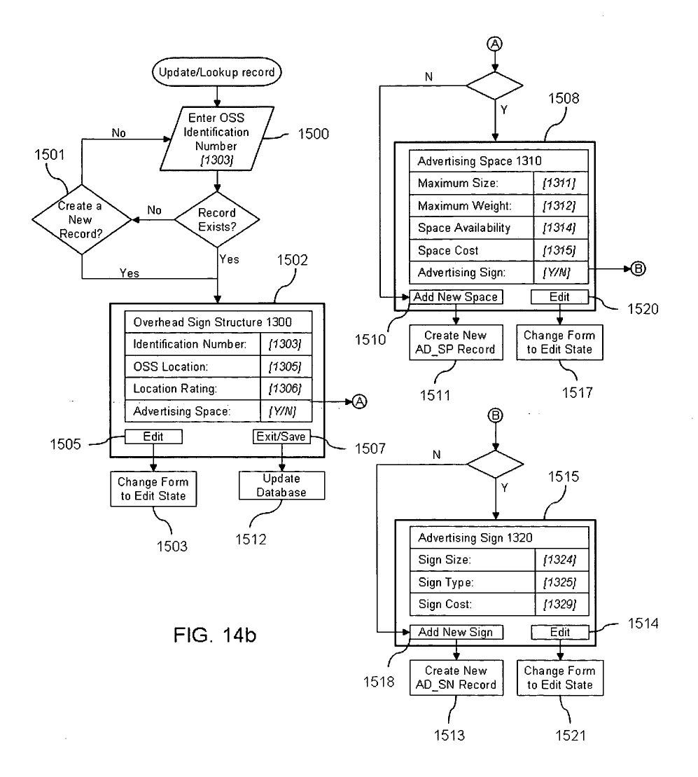

OSS managing party 900 may include a department responsible for allocating proper advertising sign space and selling the space to advertising entities 901. The overhead sign structure inventory database can be used to determine adequate advertising space. Each overhead sign structure can be checked for overall sign area surface and maximum allowed load. The available sign area and weight can be determined by subtracting the used sign area and weight (e.g., by existing signs or attachments) from the maximum area and load of the overhead sign structure. Each potential advertising space can be presented for approval before an assigned board. Once approved, the available sign area and weight can be defined as advertising space ready for sale. Advertising database 1302 of FIG. 14a, described in greater detail below, can be created to keep track of available advertising space and corresponding data. The advertising space can be offered for sale to advertising entity 901 in raw form requiring advertising entity 901 to provide and mount an advertising sign on overhead sign structure. Alternatively, OSS managing party 900 can financially provide for mounting advertising signs on the overhead sign structures 911. In either case, OSS managing party 900 or advertising entity 901 will hire contractor 930 to mount the advertising sign on the overhead sign structure 911. Contractor 930 will purchase the advertising sign from manufacturer or supplier 940 and install the advertising sign on the overhead sign structure 911. The overhead sign structure and the installed advertising sign are then inspected by OSS managing party 900 for quality control. Advertising database 1302 of FIG. 14a may then be updated to include the presence of the advertising sign, its size, type, price, availability, and the like.

Many issues surround the sale of potential advertising space. For example, the cost, time period of availability, manufacture period and process, etc. must be predefined. For example, the advertising space could be available in time increments of one day, a number of months, annually, etc. If a variable message or an LCD advertising sign is used the advertising space can be further incremented since a number of messages can utilize the space simultaneously. Additional costs can be applied for different type of advertising signs. For example, traditional billboards can include advertisement installation fees. Further options can be offered such as illumination. Illuminated billboards can increase the space costs since the advertisement can be viewed day and night. Digital billboards are also priced at higher rates as they provide a better advertising medium. If an advertiser selects a digital billboard, additional fees can be charged for maintenance and electricity costs.

Once the costs of the advertising space are defined advertising entity 901 provides the desired advertisement to be displayed on the advertising signs. Once the media is prepared, OSS managing party 900 or the advertising entity 901 instructs contractor 930 to display the advertisement on advertising sign 912. This could include attaching an advertising poster to a billboard, sending advertising digital content to a LCD display, or the like. After displaying the advertisement 912, the site may be inspected by OSS managing party 900 to assure that the advertisement is installed properly.

The benefit of the present system is that maintenance costs 920 for mounting advertising signs 911 and costs associated with displaying the advertisements on advertising signs 912 are thus offset by advertising space costs 921 received from advertising entity 901. Advertising space cost 921 can further offset some of the costs associated with erecting and maintaining the overhead sign structures 910. And since contactors 930 are hired to mount the advertising signs 911 and display the advertisement 912 and staff are hired to manage the advertising system, the aforementioned system creates jobs benefiting to the local, state, and/or federal government.

In this example, advertising entity 901 consists of advertising agencies which provide advertising services to manufacturers or service providers 902. Advertising entity 901 can also be an integral division of the manufacturer or the service provider. In short, advertising entities 901 sell advertising services to manufacturers or service providers 902. Advertising services include creating the advertisements and providing the advertising space. Production cost 923 allotted by advertising entity 901 to produce the advertisements 913 is offset by advertising fee 924 received from the manufacturer or the service provider. Advertising fee 924 can also include an advertising space sales price which offsets advertising space cost 921 paid by advertising entity 901 to OSS managing party 900. Further, advertising entity 901 purchasing the advertising space from OSS managing party 900 at a reduced price can resell it to manufacturers or service providers 902 at a higher retail price.

Advertising fees 924 vary according to the advertising space and the advertisement types. For traditional billboard space, advertising entity 901 may create advertising posters or panels such as 501 and 611 shown in FIGS. 9-10 with advertisements printed thereon. Advertising fees may include the advertising poster or panel material costs, printing costs, labor costs, and the like. Further, for digital billboard space, such as 700 and 800 illustrated in FIGS. 11-12, advertising entity 901 creates digital advertisement content which requires labor fees.

Manufacturer or service provider 902 purchase advertising services from advertising entity 901 to advertise products, services, ideas, or the like. The displayed advertisement on the advertising sign increases the number of customer 903 impressions and thus manufacturer or service provider 902 is benefited by increased amount of sales or demand of the advertised product, service, or idea. Thus, advertising fees 924 are offset by increased sales 926 of the advertised product, service, and the like.

FIG. 14a illustrates advertising database 1300 kept by OSS management party 900 to keep records of available advertising space. Advertising space records can be entered or viewed by OSS management party personnel via computer 1301. Advertising database 1302 can keep records 1300 related to each overhead sign structure. Each overhead sign structure record 1300 can consist of overhead sign structure identification number 1303 similar to the pre-existing overhead sign structure number. If the overhead sign structure was not allocated an identification number, the OSS management personnel may assign a number to the overhead sign structure. Record 1300 may further identify the overhead sign structure by its location 1305 which may consist of city, state, roadway number, roadway name, mile number, or the like. For advertising purposes, advertising location can be rated according to the average number of impressions and rating record 1306 can be stored in advertising database 1302. Any rating scale can be used. For example, a subjective scale from 1-5 can be used. The rating may rise for frequently used highways, highways located in urban areas or commercial areas, and so forth. The OSS management party can charge higher costs for advertising space located in higher rated locations.

Each overhead sign structure record 1300 can consist of advertising space records 1310 (if applicable). One overhead sign structure record 1300 can consist of multiple advertising space records 1310 each identifying a separate section of an overhead sign structure. Such advertising sections can include the front of the structure (i.e., adjacent to traffic signs) and the back of the structure (i.e., opposite of traffic signs). Each advertising space section record 1310 can include data regarding maximum size 1311 and maximum weight 1312 available for advertising signs. Advertising space cost data 1315 can be utilized to quote a preliminary price for the advertising space. Advertising space cost 1315 can be affected by location rating 1306 and other like factors. Advertising space record 1310 can further indicate whether the space is available for sale 1314 and if not when it will be available. For example, the space can be already purchased and will be only available for resale on a certain date.

Each advertising space record 1310 can consist of multiple advertising sign records 1320 identifying already installed and ready to use advertising signs. Large advertising space can accommodate multiple advertising signs each comprising advertising sign records 1320. Advertising sign record 1320 can specify size 1324 of the advertising sign, type 1325 of the advertising sign (e.g., vinyl covered billboard, painted billboard, variable message display, etc.), and additional costs 1329 for using that advertising sign.

FIG. 14b illustrates a flow diagram of exemplary operation of database 1302 in FIG. 14b. An OSS management personnel using computer 1301 can add, update, or lookup advertising space records stored in database 1302. In one embodiment, the user can enter overhead sign structure identification number 1303 in 1500 to recover overhead sign structure record 1300 or to verify whether such record exists. Of course, any other information or search term indicative of the record can be entered by the user to recover a record from database 1302. The user is notified if no record exists that corresponds to the entered identification number in 1500 and is asked whether a new record should be created 1501. If a new record is not desired the user can reenter the overhead sign structure identification number 1303 in 1500. Otherwise the user is presented with a blank record form 1502 and can enter desired parameters by clicking on edit button 1505. In such a case, record form 1502 will change to an edit state allowing the user to enter input field information indicating overhead sign structure identification number 1303, location 1305, and location rating 1306. The user can exit and save the entered information by pressing exit/save button 1507 at any time, which updates the database as depicted by 1512.

If a record is found associated with the entered overhead sign structure identification number 1303, record form 1502 will be populated with information stored in overhead sign structure record 1300. The user can edit the stored information by pressing edit button 1505 and the form will change to an edit state 1503. If overhead sign structure record 1300 includes at least one advertising space record 1310, at least one advertising space form 1508 will be displayed. If no advertising space records exist in database 1302, the user can add a new advertising record by pressing “add new space” button 1510 and the database will create a new advertising space record 1511. A blank advertising space form 1508 will then appear where the user can enter new information by pressing edit button 1520 to change the form into an edit state 1517. Such information includes the advertising space maximum size 1311, maximum weight 1312, space availability 1314, and space cost 1315. Additional advertising space records can be created by pressing “add new space” button 1510 and a blank advertising space record form would appear.

Further, any saved advertising sign record 1320 will be displayed in advertising sign form 1515 pre-populated with the advertising sign record information including the advertising sign size 1324, sign type 1325, and sign cost 1329. The user can add a new advertising sign record by pressing “add new sign” button 1518 which will display a blank advertising sign form 1515 and a new record would be created 1513. Data can be entered into the text fields by pressing edit button 1514 and thus converting form 1515 into an edit state 1521. By using the advertising database system of FIGS. 14a-14b the OSS managing party can keep an inventory of advertising sign space, its availability, costs, and the like. Database 1302 will be updated by OSS managing party personnel as each overhead sign structure is erecting, advertising space is allocated, and advertising signs are mounted.

As a result, the local, state, and federal governments, as well as advertising entities, the manufacturer, and the service provider benefit from the advertising revenue created from the aforementioned advertising medium. In addition, each local, state, and/or the federal government could create jobs. Each state, local government, or the federal government would benefit greatly by converting assets that bear a maintenance cost to an asset that produces a unique high profit margin revenue stream.

From the foregoing description of the preferred embodiment, which has been set forth in considerable detail for the purpose of making a complete disclosure of the present invention, it can be seen that the present invention comprises advertising methods for displaying advertisements using overhead sign structures. Specifically, methods of advertising are provided comprising the steps of: mounting at least one advertising sign on unused space of an overhead sign structure, i.e. adjacent to or behind traffic signs, receiving a payment from an advertiser for an advertisement, and displaying the advertisement on the advertising sign, wherein the advertising sign is capable of being interchanged with advertisements. Optionally, a portion of the payment can be delivered to a party associated with managing the overhead sign structure. It will be appreciated by those skilled in the art that changes can be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

What is claimed is:

1. A method of advertising comprising the steps of:
mounting at least one advertising sign on unused space of an overhead sign structure;
receiving a payment from an advertiser for at least one advertisement;
delivering a portion of said payment to a party associated with managing said overhead sign structure; and
displaying said advertisement on said at least one advertising sign;
wherein said at least one advertising sign is capable of being interchanged with advertisements; and
wherein said unused space is defined by space not occupied by a traffic sign.

2. A method of advertising comprising the steps of:
mounting at least one advertising sign adjacent to at least one traffic sign on an overhead sign structure;
receiving a payment from an advertiser for at least one advertisement;
displaying said advertisement on said at least one advertising sign;
wherein said at least one advertising sign is capable of being interchanged with advertisements.

3. A method according to claim 2 wherein said method further comprises the step of:
delivering a portion of said payment to a party associated with managing said overhead sign structure.

4. A method of advertising comprising the steps of:
mounting at least one advertising sign behind at least one traffic sign on an overhead sign structure;
receiving a payment from an advertiser for at least one advertisement;
displaying said advertisement on said at least one advertising sign;
wherein said at least one advertising sign is capable of being interchanged with advertisements.

5. A method according to claim 4 further comprising the step of: delivering a portion of said payment to a party associated with managing said overhead sign structure.

6. A method according to claim 5 wherein said party associated with managing said overhead sign structure comprises at least one selected form a group consisting of a local government, a state government, a federal government, and a municipal government.

7. A method according to claim 5 wherein said portion of said payments offsets maintenance costs associated with said mounting said at least one advertising sign behind at least one traffic sign on an overhead sign structure.

8. A method according to claim 5 wherein said portion of said payments offsets maintenance costs associated with said displaying said advertisement on said at least one advertising sign.

9. A method according to claim 4 wherein said overhead sign structure is selected from a group consisting of a cantilever, an arm, a truss, a beam, a plank, a single arm, a dual arm, a dual trussed arm, a dual arm butterfly, a plane truss, a tri-truss, a four chord truss, a three chord truss, a two chord truss, and a triangular truss.

10. A method according to claim 4 wherein said at least one advertising sign is selected from a group consisting of an advertisement panel receiving frame, a billboard, a billboard receiving frame, a removable billboard, an electronic sign, a digital sign, a variable message display, a light-emitting diodes display, and a liquid crystal display.

11. A method according to claim 4 wherein said displaying said advertisement on said at least one advertising sign comprises the step of:
permanently adhering said advertisement to said at least one advertising sign.

12. A method according to claim 4 wherein said displaying said advertisement on said at least one advertising sign comprises the step of:
removably adhering said advertisement to said at least one advertising sign.

13. A method according to claim 4 wherein said displaying said advertisement on said at least one advertising sign comprises the step of:
delivering digital content of said advertisement to said at least one advertising sign.

14. A method according to claim 4 wherein said displaying said advertisement on said at least one advertising sign comprises the step of:
sliding said advertisement into a frame of said at least one advertising sign.
